(19) United States
(12) Patent Application Publication
(10) Pub. No.: US 2012/0011805 A1
(43) Pub. Date: Jan. 19, 2012

(54) STEEL AND WOOD COMPOSITE STRUCTURE WITH METAL JACKET WOOD STUDS AND RODS

(76) Inventor: WeiHong Yang, Sunnyvale, CA (US)

(21) Appl. No.: 13/243,909

(22) Filed: Sep. 23, 2011

Related U.S. Application Data
(63) Continuation-in-part of application No. 12/804,601, filed on Mar. 19, 2010.

(51) Int. Cl. E04C 3/28; B32B 9/00; B32B 15/04; E04G 21/14; B32B 15/10

(52) U.S. Cl. 52/834; 52/741.1; 428/464; 428/457; 428/318.4

(57) ABSTRACT

A composite member provides support to a structure. A wooden core of the composite member has a perimeter and a length. The wooden core provides support to the structure. A metal jacket is attached to the perimeter of the wooden core of the composite member and spans the entire length. The metal jacket provides also support to the structure. Furthermore, the interaction between the wooden core and the metal jacket provide a combination of strength that surpasses the sum of individual strengths.

### CROSS-REFERENCE TO RELATED APPLICATIONS

This application claims the benefit of priority as a continuation-in-part to U.S. patent application Ser. No. 12/804,601, filed on Mar. 19, 2010, entitled STEEL-WOOD COMPOSITE STRUCTURE USING METAL JACKET WOOD STUDS, by WeiHong Yang, the contents of which are hereby incorporated by reference in its entirety.

### BACKGROUND

1. Technical Field

The present invention relates generally, to construction material, and more specifically, to a construction support member composed of a wood core and a metal jacket.

2. Prior Art

In light-framed construction, support for structures is conventionally provided by members composed of a single material, predominantly either wood or metal studs. These single-material members are often vulnerable to failure due to characteristics of the material. For examples, while wood is very vulnerable to fire and termite, a metal stud has inherent problems of pre-mature failure due to weak connection and local buckling. Furthermore, use of certain materials can have a negative effect on the environment. For example, inefficient use of timber wastes trees, a valuable natural resource. Also, timber is often treated for use in exterior construction which can add pollutants to the environment. In another example, pressure treated wood produces a large volume of waste water with pollutants.

In heavy duty construction, composite techniques are often used to achieve higher structural performance. A composite structure combines different materials together to form a new structure. Since it fully utilizes the potential of individual materials, the advantages of composite structures have been well recognized in the engineering community during the past decades.

However, past applications, such as concrete-filled steel tubes and composite floor decks, mostly involve combining steel and concrete in various forms, and are primarily used in commercial buildings and infrastructures.

### SUMMARY

The above-mentioned needs are met by an apparatus, system, method, and method of manufacture for using a composite member for enhanced structural performance in light-framed construction.

A composite member provides support to a structure. In one embodiment, a wooden core of the composite member has a perimeter and a length. The wooden core provides support to the structure. In another embodiment, a metal jacket is attached to the perimeter of the wooden core of the composite member and can span the entire length. The metal jacket also provides support to the structure.

Furthermore, the interaction between the wooden core and the metal jacket provide a combination of strength that surpasses the individual strengths. Specifically, while the metal jacket provides lateral confinement for the wooden core to increase the compressive strength and ductility of the core, the wooden core also provides lateral support for the metal jacket to prevent pre-mature local buckling failure of the jacket. Thus, the overall strength and ductility of the new composite member is expected to be much higher than the sum those of wooden core and metal jacket when used alone.

Advantageously, the composite member provides higher strength and ductility, stronger yet simpler connections, better fire and erosion resistance, higher quality, lighter weight, and is environmental-friendly. The present invention covers the whole structural system, which includes components, their connections, vertical gravity framing systems and lateral seismic/wind systems.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a schematic diagram illustrating an example of composite floor joists, according to one embodiment.

FIG. 2 is a schematic diagram illustrating an example of composite wall studs, according to one embodiment.

FIG. 3 is a schematic diagram illustrating an example of partial composite gravity framing system, according to one embodiment.

FIG. 4 is a schematic diagram illustrating an example of composite joist used as roof rafter, according to one embodiment.

FIG. 5 is a graph illustrating an example comparison of performance of composite beam with that of wood beam and metal stud beam, according to one embodiment.

FIG. 6 is a schematic diagram illustrating an example of composite post or column, according to one embodiment.

FIG. 7 is a graph illustrating an example comparison of performance of composite post with that of wood post and metal stud post, according to one embodiment.

FIG. 8 is a schematic diagram illustrating an example of composite post installed as an isolated column, according to one embodiment.

FIG. 9 is a schematic diagram illustrating an example of composite post used as exterior fence post, according to one embodiment.

FIG. 10 is a schematic diagram illustrating an example of composite studs used in a load bearing wall with splice at top for cord continuity, according to one embodiment.

FIG. 11 is a schematic diagram illustrating an example of composite studs used in typical construction of light-framed shear walls, currently used in residential building and low-rise commercial structures, according to one embodiment.

FIG. 12 is a graph illustrating an example comparison of performance of composite shear wall with that of wood stud or metal stud shear walls, according to one embodiment.

FIG. 13 is a schematic diagram of a circular composite pole of truncated-cone shape, according to one embodiment.

FIG. 14 is a schematic diagram of a circular composite rod, according to one embodiment.

FIG. 15 is a schematic diagram illustrating an example of the composite poles of FIG. 13, according to one embodiment.

FIG. 16 is a schematic diagram illustrating an example of the composite rods of FIG. 14, according to one embodiment.

FIG. 17 is a schematic diagram illustrating composite joist used as floor framing supported on a typical stud wall, according to one embodiment.

FIG. 18 is a schematic diagram illustrating a triangular roof truss made of composite studs, according to one embodiment.

FIG. 19 is a schematic diagram illustrating magnified views of truss connections shown in FIG. 18, according to one embodiment.

FIG. 20 is a schematic diagram illustrating segment of open web truss made of composite studs, according to one embodiment.

FIG. 21 is a schematic diagram illustrating composite post with composite beams at bottom and top, according to one embodiment.

FIG. 22 is a schematic diagram illustrating composite sheathing board made with laminations or sandwich of plywood and metal sheets, according to one embodiment.

FIG. 23 is a schematic diagram illustrating magnified views of composite sandwich board of FIG. 22, according to one embodiment.

FIG. 24 is a schematic diagram illustrating magnified views of composite laminated board of FIG. 22, according to one embodiment.

### DETAILED DESCRIPTION

An apparatus, system, method, and method of manufacture for using a composite member for enhanced structural performance are described herein. The following detailed description is intended to provide example implementations to one of ordinary skill in the art, and is not intended to limit the invention to the explicit disclosure, as one of ordinary skill in the art will understand that variations can be substituted that are within the scope of the invention as described.

A composite member combines different materials together. Examples of a composite member include, but are not limited to, a joist or beam, post or column, stud or rod, or pole, or other supporting member. The described technique can also be applied to components of a member, connector, rafter, truss, structural system, vertical gravity framing system, lateral seismic or wind system, and the like.

In an embodiment, a steel-wood composite structure using light gauge steel sheet wrapping around standard wood members to achieve exceptional structural performance that is superior to that when either steel or wood used alone. Composite mechanism is achieved through the interaction between the wooden core and the metal jacket. Specifically, while the metal jacket provides lateral confinement for the wooden core to increase the compressive strength and ductility of the core, the wooden core also provides lateral support for the metal jacket to prevent the pre-mature local buckling failure of the jacket. Thus, the overall strength and ductility of the new composite member is considerably higher than the sum of those of the wooden core and metal jacket when used alone.

Furthermore, the composite member described herein is environmentally-friendly. First, because of the lateral confinement provided by the metal jacket, recycled material, such as glued wood chips, can be used as core material just as effectively as new lumber. Second, because the metal jacket protects the core from water and weathering, composite studs can be used for exterior construction without chemical treatment. As a result, fewer trees are taken from the environment and fewer pollutants are released into the environment. A popular exterior framing member in the current market is composed of pressure treated lumbers, which consume energy and produce large quantity of waste water during manufacturing and causing chemical pollutions during manufactures and after installations.

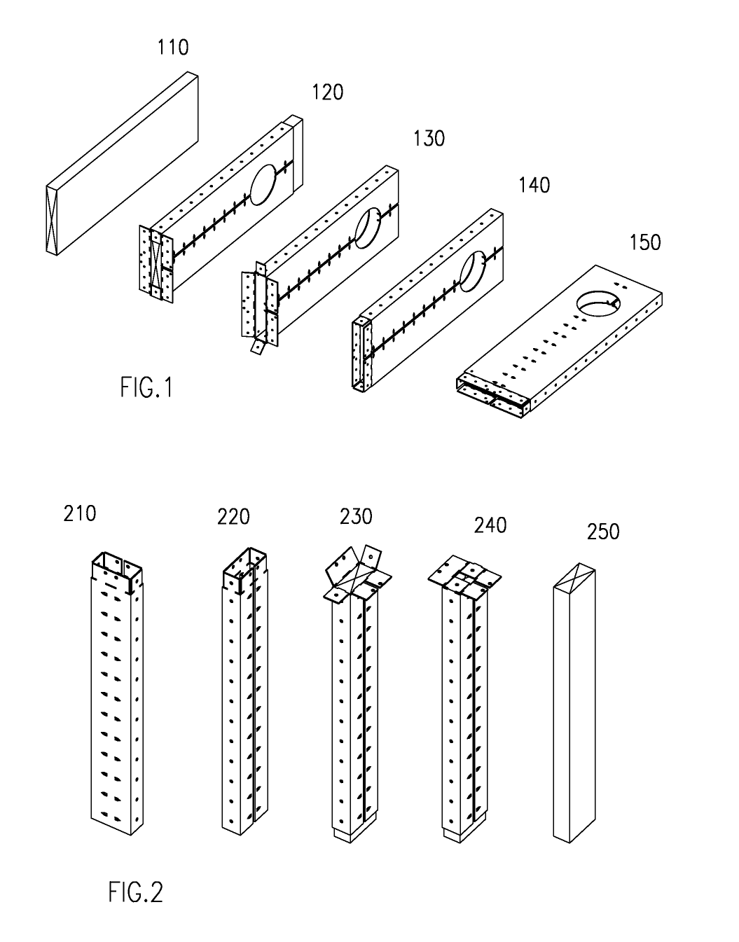

FIG. 1 shows construction of composite floor joists 120. Wooden core of standard wood floor joists can be made of saw lumber, or engineering wood like LSL, LVL or PSL 110. The jacket 130, 140, 150 can be made of light-gauged cold-formed steel sheet. Note that in the embodiment shown, the end tags can be bend in to into opposite direction, as needed, for connection.

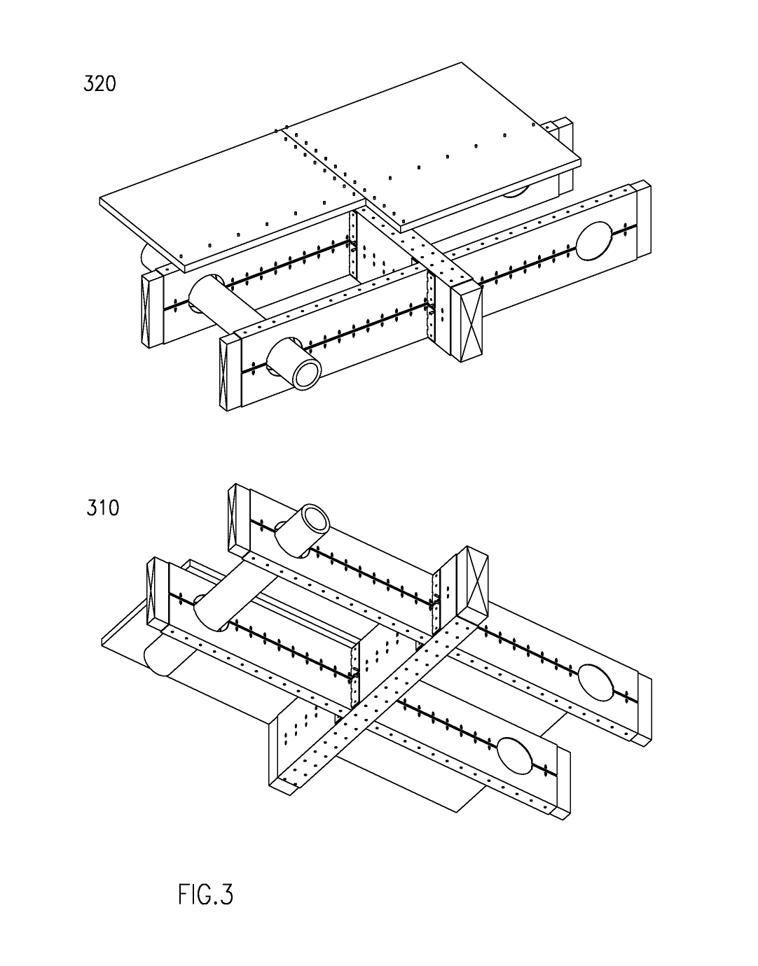

FIG. 2 shows construction of composite wall studs 230, 240. Wooden core 250 can be made of standard wood studs, like 2×4, 2×6 etc. Jacket can be made of light-gauged cold-formed steel sheet 210, 220. Note that the end tags can be bend in to opposite direction, as needed, for connection.

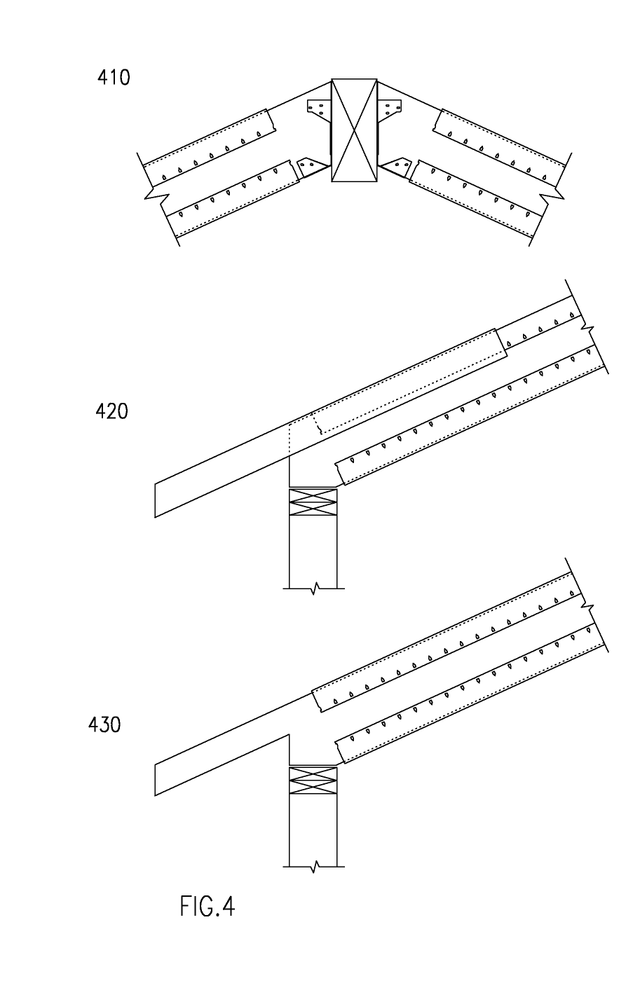

FIG. 3 shows a composite gravity framing system. The connection concept of the entire system can be similar to a LEGO piece, with pre-punched holes in a certain pattern that matched for different sides and directions. In this case, there are four pre-punched holes at tags at each joist end, the location of which match the teethed holes at the sides of composite girder. These allow quick temporary field installation without drilling. Additional nails or screws can be added afterward, by different crews, for higher capacity as needed. Drilling may be needed depending on the thickness of the metal jacket. There are also pre-punched holes at the metal jacket for HVAC ducks. There is no need for field cutting of any metal sheet. AS shown in top view 320, plywood floor sheathing and gypsum ceiling board can be nailed or screwed directly into framings without drilling, because there are already pre-punched holes at 2 inch apart at the top and bottom of the framing. A bottom view 310 is also shown. A ceiling board not shown for the purpose of clarity.

FIG. 4 shows a composite joist 410 used as roof rafter. Connection to ridge beam made of regular wood. By stripping off a small portion of metal jacket at the end, a composite rafter can easily and seamlessly fit into conventional wood framing without special tools. This is particularly useful when just one or a few heavily loaded members call for higher strength. Without increasing the depth of entire roof framing, significant saving can be achieve to use composite joists for selected member, and the remaining majority still using regular wood members. For example, 2×12 at 16 inch on center regular wood joists may be needed without composite joists, versus 2×10 @ 24 inch on center with using one or two composite joists. Rafter tail connection design one 420 is achieved by stripping off a small portion of metal jacket at field without special tool, and nail a regular 2× rafter tail to the composite rafter. Rafter tail connection design two 430 is achieved by stripping off a longer portion of metal jacket and cut it to require shape, just as a regular 2× wood rafter.

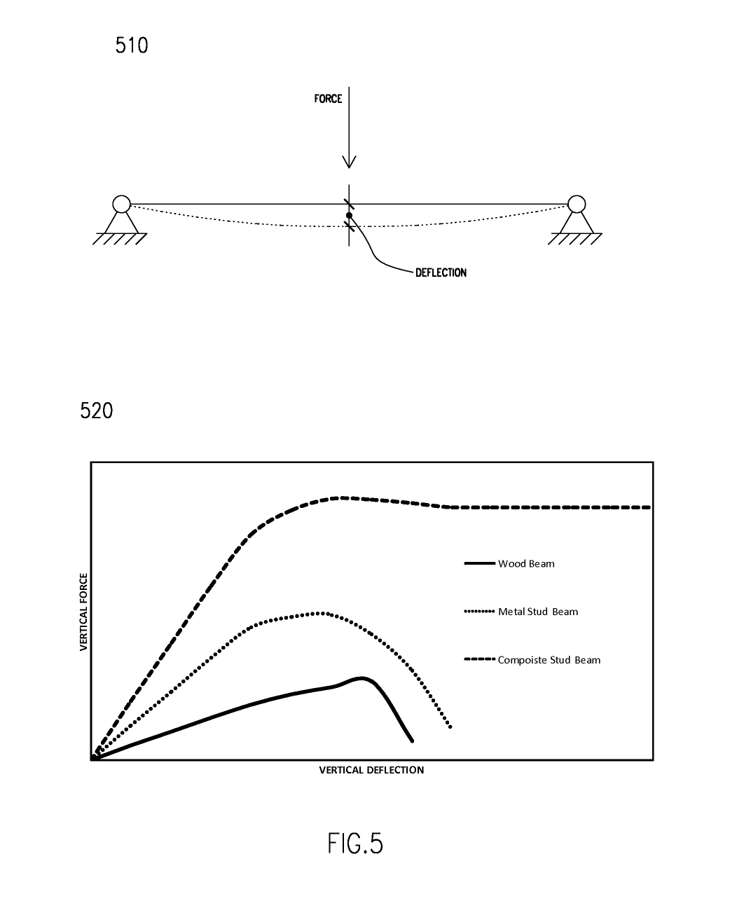

FIG. 5 includes a graph 520 showing a comparison of deflection 510 performance of a composite beam against a wood beam and metal stud beam. Note that, due to the composite mechanisms, significant increase in both strength and ductility are expected for composite joists.

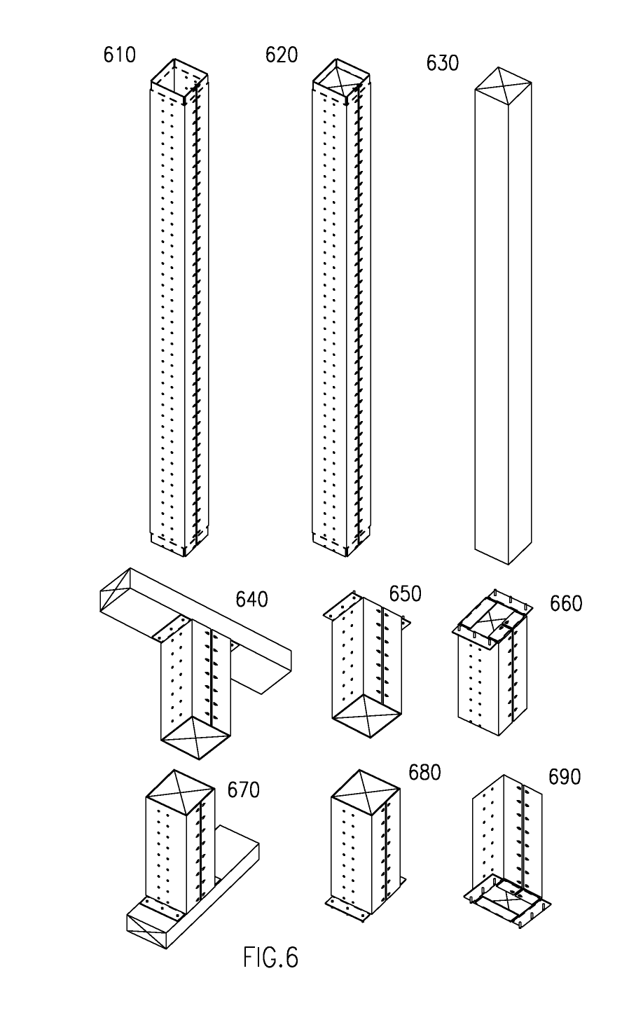

FIG. 6 shows construction of composite post or column. In metal jacket 610, there are two rows of pre-punched holes at 2 inch on center at all four sides. These holes are for connection wall sheathing with regular nails or screws. Since the location pre-made at factory, it can easily achieve more precise nailing pattern without measurement. The construction quality will be dramatically improved. It is particularly true for residential constructions, since contractors and workers in the sector of residential projects can lack rigorous training and skills. For example, when approved plans call for 4 inch on center nailing pattern, workers at field may not follow the instruction precisely. Consequentially, nailing can be anywhere between 3 to 5 inches. With pre-punched metal jacket, it will be much easy for both worker and inspector.

A wooden core post 630 can be 4×4, 6×6, 4×6 saw lumber or engineering wood like LVL or PSL. Currently, when the strength of a 6×6 saw lumber is not adequate, the engineer would use a 6×6 PSL to substitute. However, PSL is not only 3-4 times more expensive than saw lumber ones, but also does not shrink like a saw lumber over the time. This sometimes can cause problems of distort deformation and/or cracks on the wall finishing. Composite post 620 is expected much cheaper and more compatible than the PSL counterpart.

When installed in a stud wall, composite post can easily connected to top plate 640, 650, 660. The technique avoids the use of toe nailing, which is the traditional method and having very low capacity.

Connection of a composite post to a regular bottom plate is similar to top 670, 680, 690. Note that two pairs of end tags are bended towards inside, this will dramatically increase end bearing capacity, and achieve higher design load.

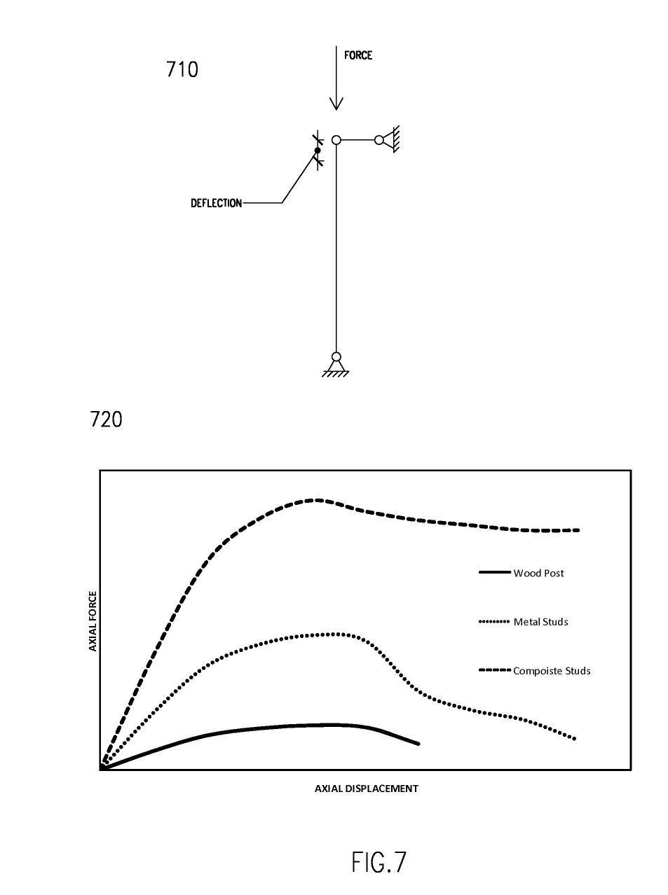

FIG. 7 shows a graph 720 comparing axial displacement 710 performance of a composite post against that of wood post and metal stud post. Note that, due to the composite mechanisms, significant increase in both strength and ductility are expected for composite posts.

FIG. 8 shows a composite post installed as an isolated column. In a top connection 810, a top portion of metal jacked is stripped off at the ends as needed, third party off-the-shelf connection hardware can be used, just like a regular wood posts. Again, this allows composite posts fit into conventional wood construction easily and seamlessly. In a bottom connection 820, a composite post is connected to concrete foundation at bottom similarly.

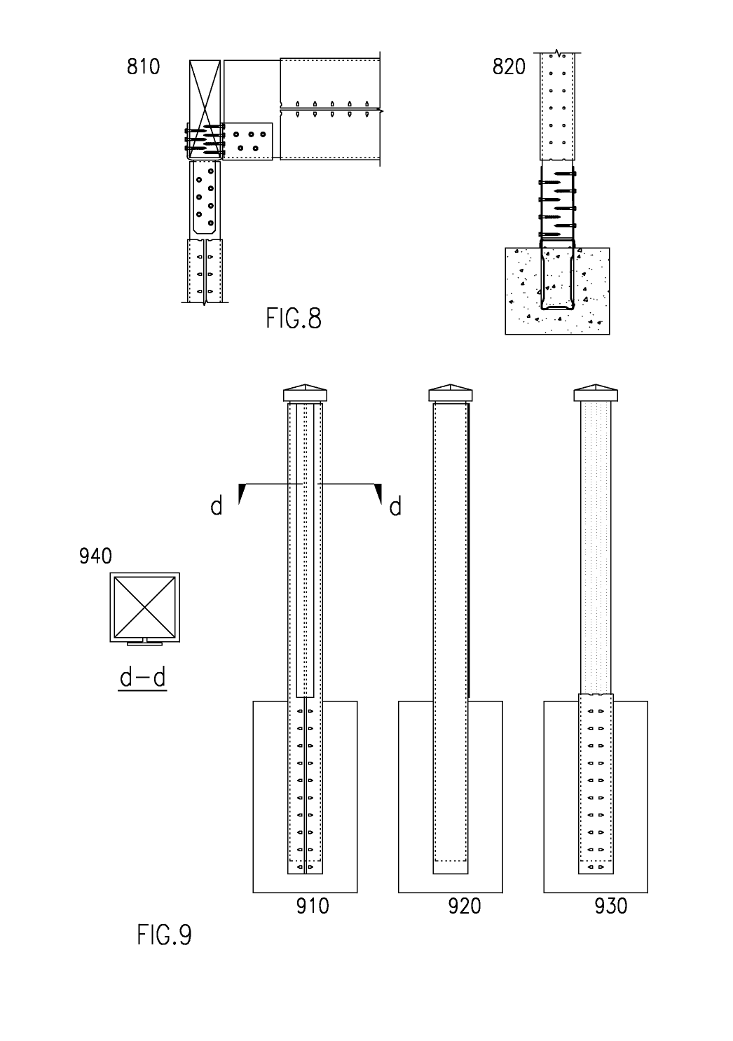

FIG. 9 shows a composite post used as exterior fence post. Because metal jacket protects the wooden core from water and weathering, it will be much more durable than that of conventional construction using pressure treated wood posts. With small increase cost, the composite fence post is expected last several times longer than wood one. As shown, there are no pre-punched holes on three of the four sides of composite post 910, 920 for water proofing. A top view of the same post 940 shows water proofing tape used to seal the gap and teethed holes.

When the metal jacked deteriorates over the time due to wreathing, it can be easily stripped off from the bottom, exposing a brand new wood post 930 which can last many more years. The metal jacket can be recycled to minimize the environmental impact.

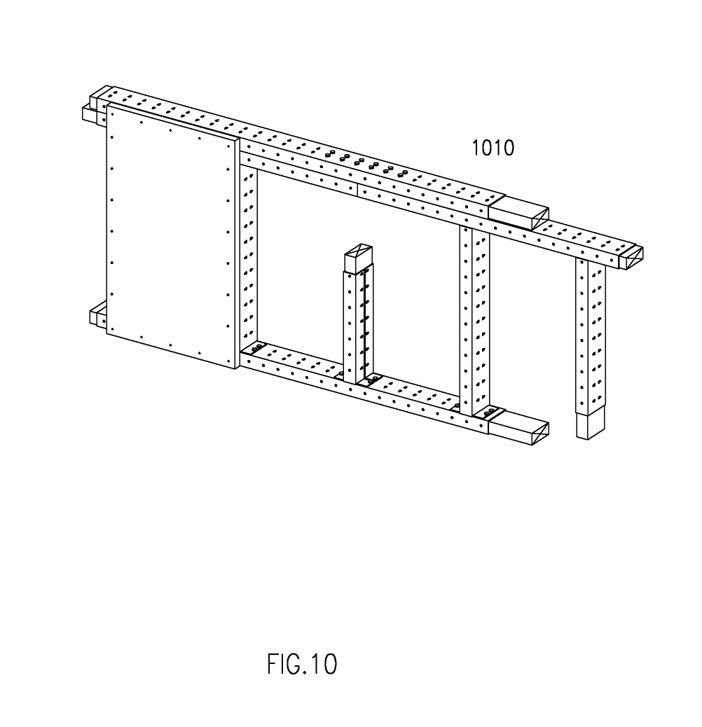

FIG. 10 shows composite studs used in a load bearing wall 1010 with splice at top for cord continuity. The construction is very similar to conventional stud wall construction, except that is entirely made of composite studs. Much higher load-capacity is expected due to higher member and connection strength. Note that LEGO like pre-punched hole patterns on the metal jackets allows precise nailing achieved easily without field drilling and measuring. Also, wall sheathing can be easily attached from either or both sides with high strength and better quality.

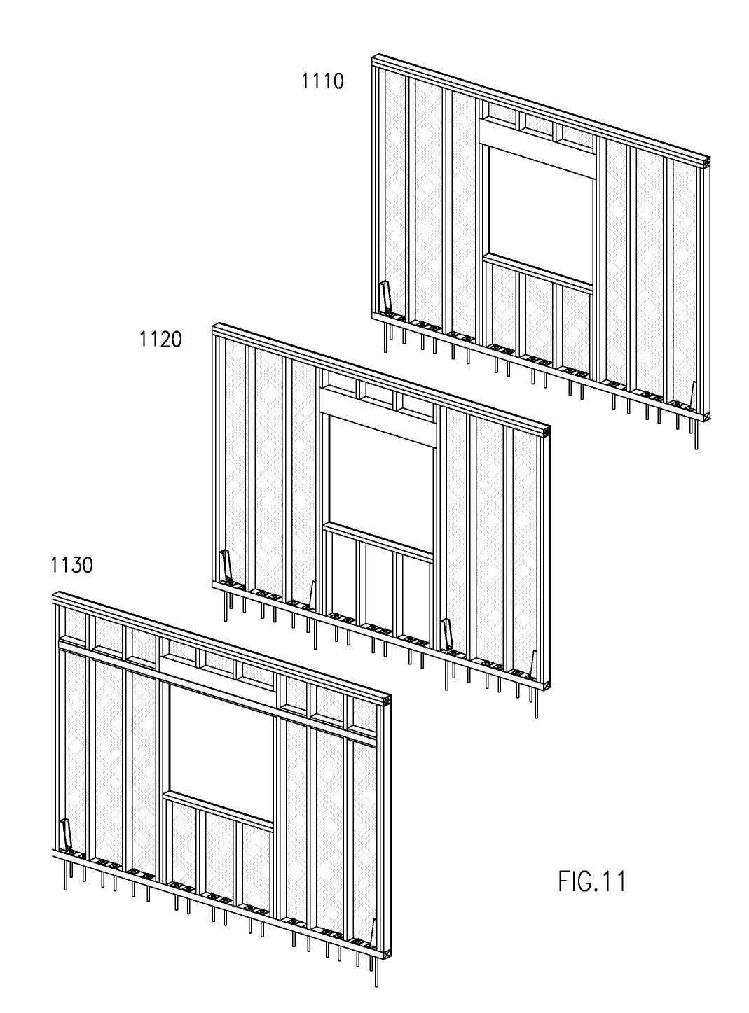

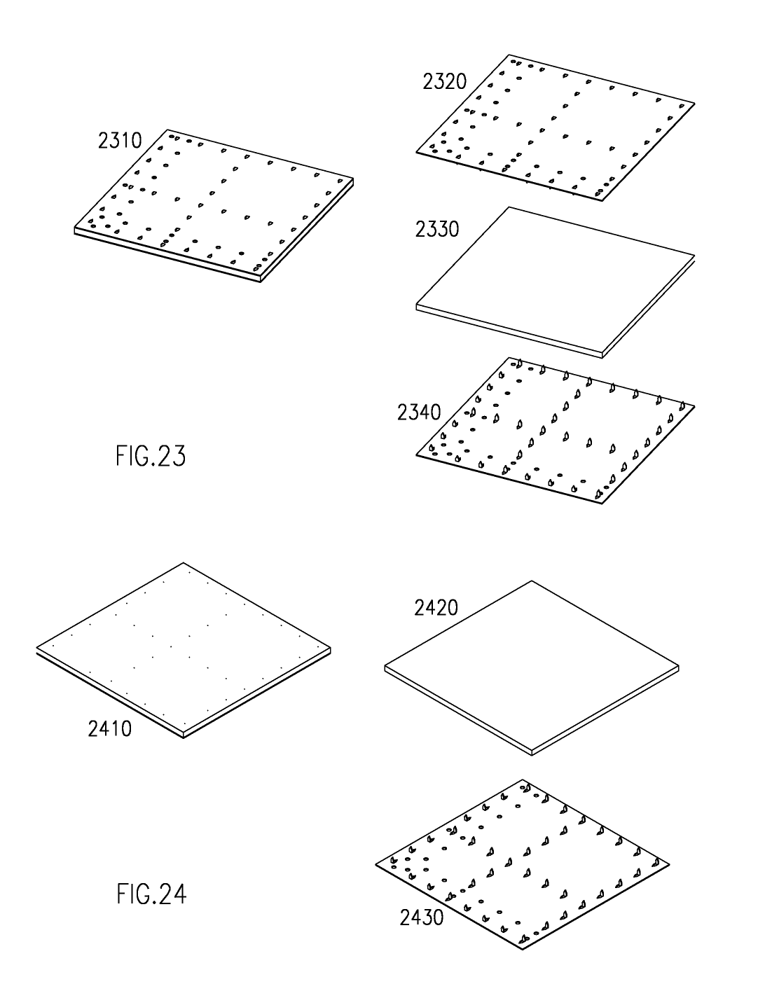

FIG. 11 shows construction of light-framed shear walls for residential building and low-rise commercial structures. The top and bottom plates and vertical studs are all made of composite studs, while conventional construction uses either wood studs or metal studs. Depending on the demand on strength and ductility, the sheathing could be either composite sandwich board or composite laminated board as shown in FIGS. 23 and 24. However, the performance of composite stud wall will be dramatically improved. A perforated shear wall construction 1110, a segmented shear wall construction 1120, and a shear wall with force transferring mechanism around opening 1130 are shown as examples.

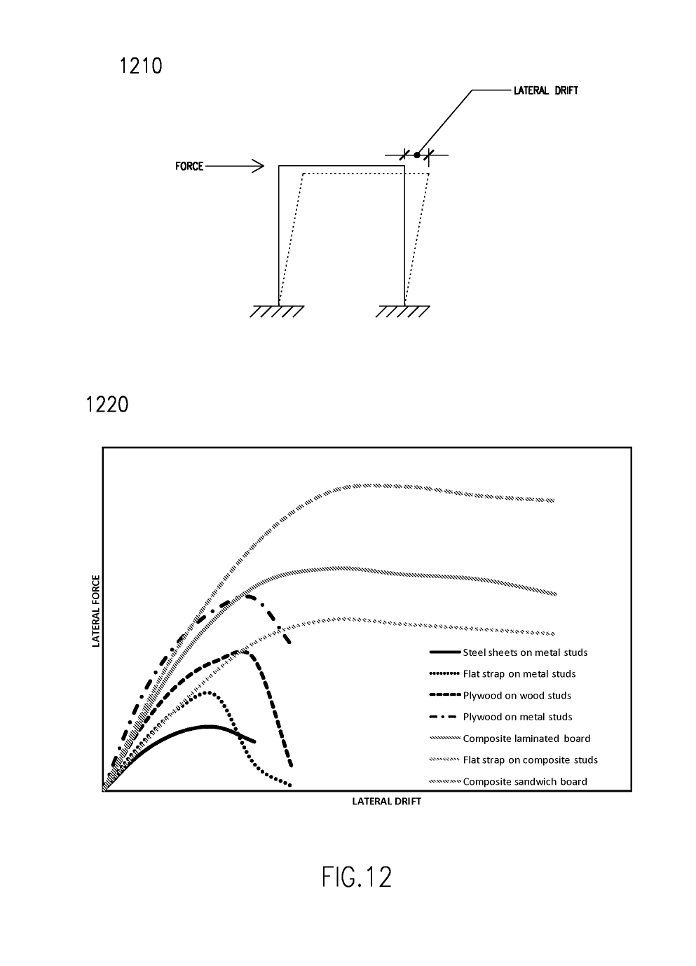

FIG. 12 shows a graph 1210 comparing lateral drift 1210 performance of composite shear wall with that of wood stud or metal stud shear walls. There is a significant increase in both strength and ductility for composite shear walls.

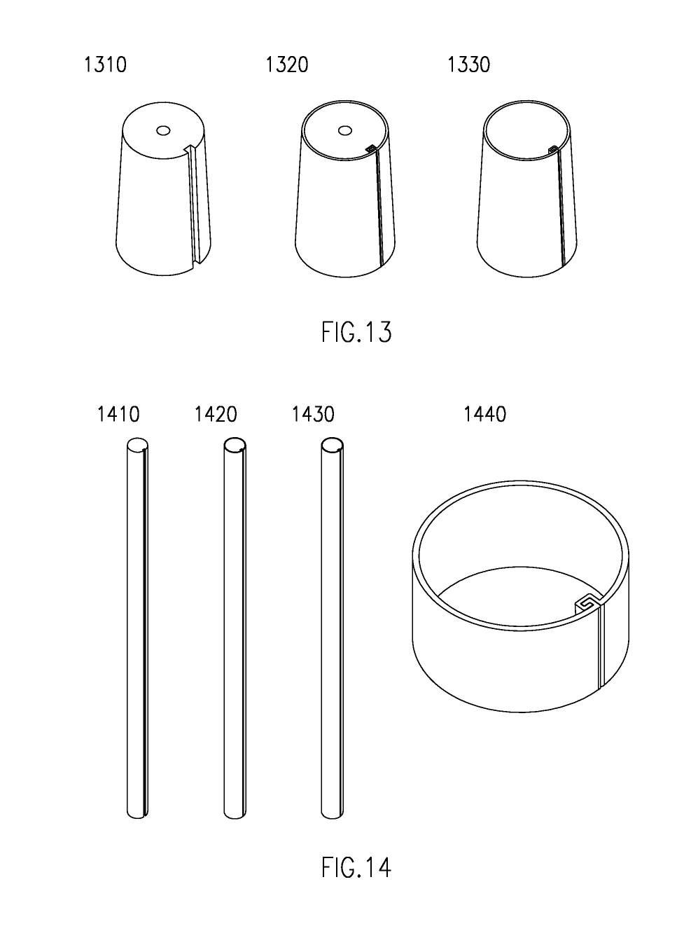

FIG. 13 shows a circular composite pole of truncated-cone shape. A solid core has a truncated-cone shape 1310. The core can be made of either regular wood, or engineering wood. For light duty usage, expansive foam, or plastic can also be used. The straight groove along the height at the perimeter is to allow metal jacket being bent into, forming a smooth exterior finishing surface for the final product. The hole at the middle is for electrical wires and cables going-through when needed, street light poles, for example. A light-gauged cold-formed steel or stainless steel jacket 1330 is attached to the perimeter of core to form a composite pole 1320.

FIG. 14 shows a circular composite rod. A solid wood rod core with a straight groove along the height at the perimeter 1410 allows light-gauged cold-formed steel or stainless steel jacket 1430 to be bent into, forming a smooth exterior finishing surface for the final circular composite rod 1420.

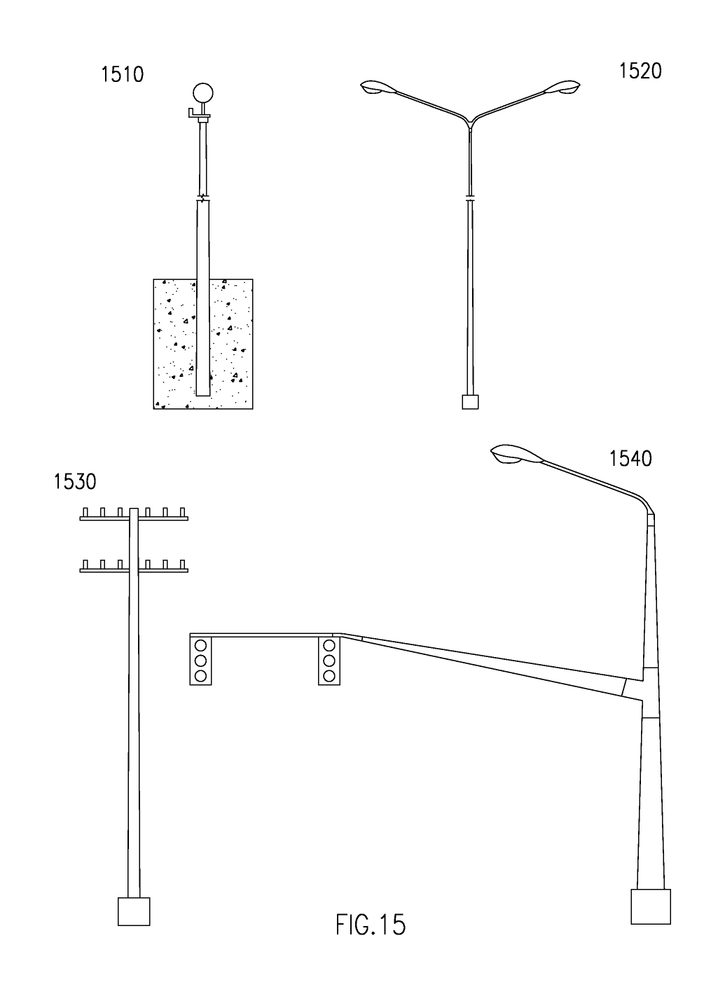

FIG. 15 shows example applications of metal-jacket composite poles of FIG. 13. As a greener, lighter and cost effective alternative, the light-weighted products are intended to replace many heavy steel or concrete infrastructures such as flag poles 1510, street light poles 1520, street poles for electrical and telecommunication wire and cables 1530, and traffic signal lights and signs supporting structures 1540. In another embodiment, poles can be used to build wind turbine supporting structures and power transmission towers.

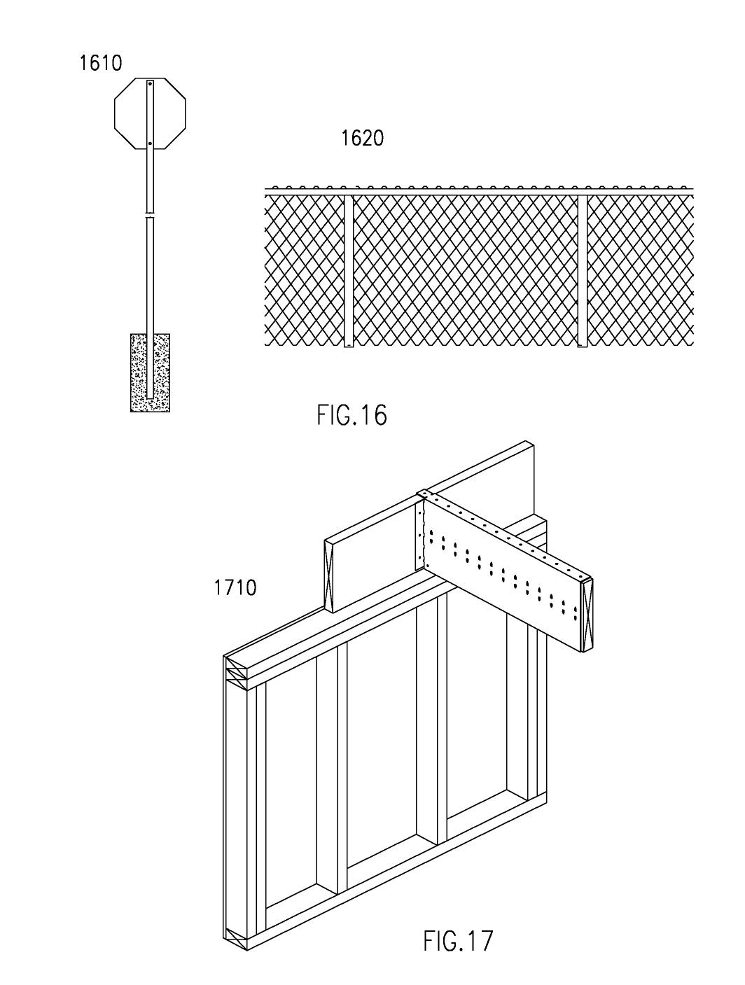

FIG. 16 shows example applications of metal-jacket composite rods of FIG. 14. As a greener, lighter and cost effective alternative, this product is intended to replace steel pipe in many light weight supporting structures such as traffic sign poles 1610, and poles for wire mesh fence 1620.

FIG. 17 shows a composite joist used as floor framing supported on a typical stud wall 1710.

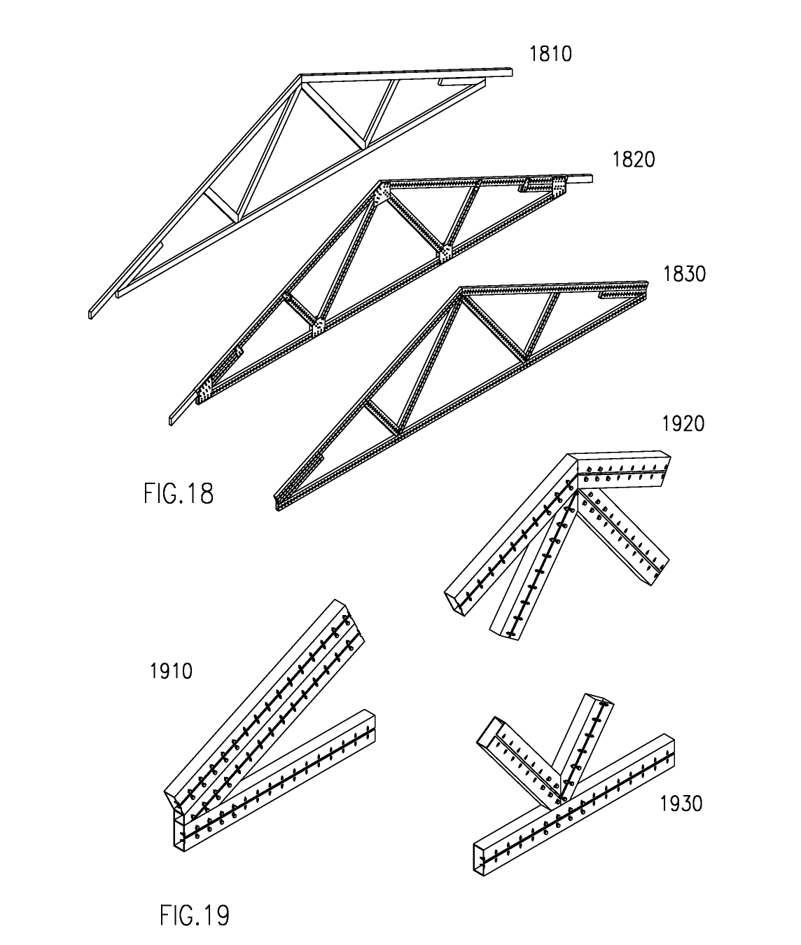

FIG. 18 shows a triangular roof truss made of composite s studs. Since both member and connections are much stronger than traditional wood or metal trusses of similar configurations, the composite truss is expected to span much longer for the same member sizes. It will expand the applicable range of traditional trusses. In other words, in some situations where steel W-shaped beams are the best solutions, now composite truss become a better and cheaper choice. Wood cores 1810 and metal jackets 1830 are used for composite studs which connected together with steel plates and screws, to form a composite roof truss 1820.

FIG. 19 shows magnified views of typical connection of the truss shown in FIG. 18. The screws are shown, but connection plates not shown for clarity. In particular, a connection at support 1910, a connection at top 1920, and intermediate connection at bottom code 1930 are shown.

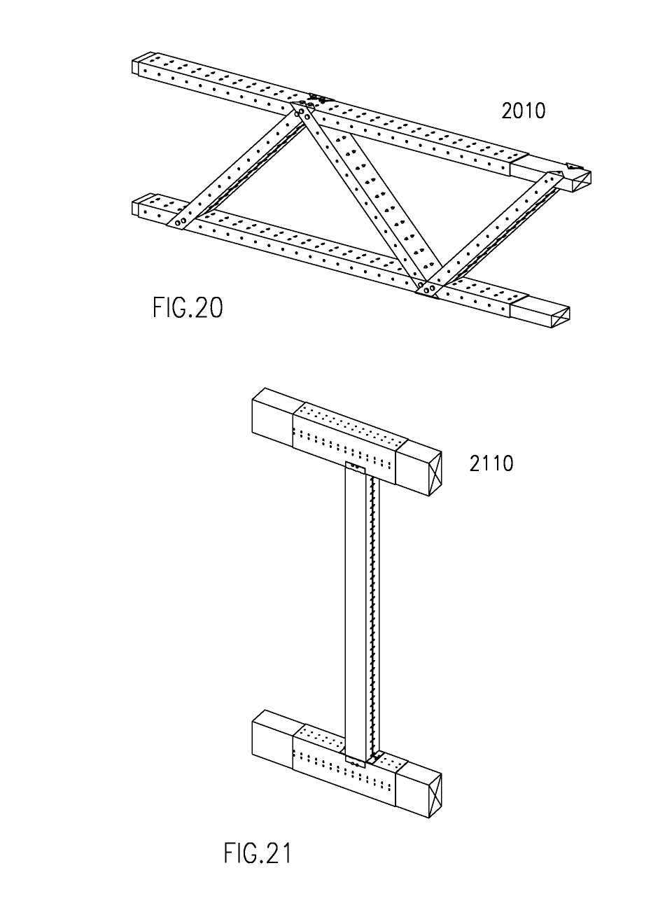

FIG. 20 shows a segment of open web truss made of composite studs 2010. Since both member and connections are much stronger than traditional wood and metal trusses of similar configurations, the composite truss is expected to span much longer for the same member sizes. It will expand the applicable range of traditional trusses. In other words, in some situations where steel W-shaped beams are the best solutions, now composite truss become a better and cheaper choice.

FIG. 21 shows a composite post with composite beams at bottom and top 2110.

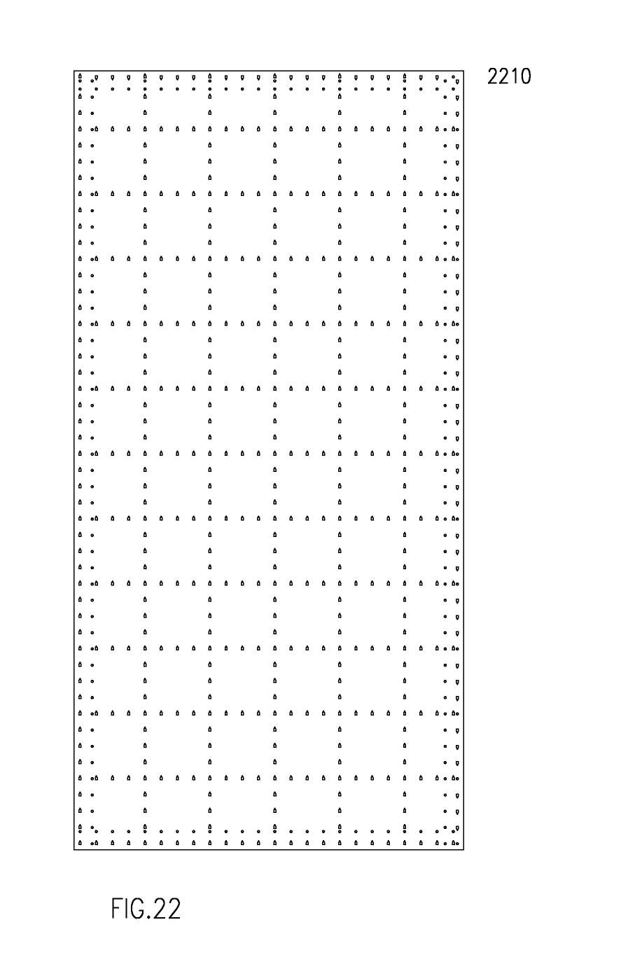

FIG. 22 shows a composite sheathing board with laminations or sandwich of plywood and metal sheet 2210. The plywood and the metal sheet are connected using glue and pre-punched teeth. It is of the same dimensions as typical plywood, i.e., 4 ft×8 ft. There are additional pre-drilled circular holes on the metal sheet. These holes follow certain pattern to allow convenient nailing at field without additional drilling. This type of sheathing is intend to be used in combination with composite stud to form a new type of shear wall systems, as shown in FIG. 11. The performance is expected much better than traditional shear walls, either wood or metal ones, as illustrated in FIG. 12.

FIG. 23 shows magnified views of composite sandwich sheathing board as shown in FIG. 22. Specifically, composite sandwich board 2310 is formed by gluing a metal sheet 2320, 2340 to both face of a wooden board 2330. There are pre-punched teeth and pre-drilled holes on the metal sheet for increased binding and easy nailing.

FIG. 24 shows magnified views of composite laminated board shown in FIG. 22. Plywood 2420 and a metal sheet with pre-punched teeth and pre-drilled holes 2430 are glued together to form a piece of composite board 2410.

The only difference between composite laminated board 2410 and composite sandwich board 2310 is that one has metal sheet on only one face for higher performance, but the other has metal sheet on both faces for maximum performance.

The following examples provide additional embodiments. Example 1: Composite stud and rod, joist, beam or post, comprising a core member that is made of either saw lumber, or engineering wood of any kind, which is of typical sizes, including square, rectangular or circular cross sections. A metal jacket fully or partially wraps around the perimeter of wood core section. The metal jacket wraps the wood core along an entire length in this particular embodiment, and is connected to the wood using any one or more of the following methods: pre-punched teeth of any pattern that bite into the wood core, or metal nails or screws that spaced at certain distance along the length of the composite member at any pattern. When the metal jacket fully wraps the core section perimeter with a overlap, the edges of the metal jacket are welded together to seal the wood core using either spot welding, or segment welding, or their combinations, or full length welding When the metal jacket fully wraps the core section perimeter with a overlap, the metal jacket is closed by twist and/or bending the overlap in any form.

The wood core can be solid, without void (except a small circular hole at center for wire and cable going-through), and is made of one piece or several segments of wood or engineered plastic or foam of any kind, or any other material having similar properties, or the combination of the above materials. The metal jacket can be made of one piece, or of several pieces of light-gauged cold-formed steel sheets, or stainless steel, aluminum, copper or alloy sheets, or any other metal sheets having similar properties, or the combination of the above material. The composite stud is with or without connecting tags or caps at one or both ends. The metal jacket is with or without pre-punched holes or teeth of any pattern for convenient field installation of any sheathing boards using nails or screws without drilling through the metal jacket at field required.

Example 2: A sheathing board, that is used in building construction, and that has pre-marked pattern at one or both faces that matches the pre-punched holes at composite studs as recited in example 1 for the purpose of locating nailing holes. The above pre-marked pattern can be of one or more of the following formats: factory drilled holes, printed marks or factory made indentations.

The sheathing material can be made of: plywood, gypsum board, oriented strand board (OSB), particle board, wood board, building board, or of any other existing and future building material, that is used as either interior or exterior sheathings.

Example 3: A building gravity system, made of the composite studs as recited in example 1, including: stud walls of typical building constructions that is made of, or partially made of, composite studs and posts, floor framing of typical constructions that is made of, or partially made of, composite joists and beams, roof framing of typical constructions that is made of, or partially made of, composite joists and beams, floor or roof trusses that is made of, or partially made of, composite studs, and composite posts that are used to support floor, deck, or roof gravity loads.

Example 4: A building lateral system, made of the composite studs as recited in example 1, including: shear walls that are made of, or partially made of, composite studs and posts, and have plywood or metal sheathing as described in examples 2, or composite sheathing board as described in example 6 on one or both faces, shear walls can be made of, or partially made of, composite studs and posts, and have with typical tension straps at one or both faces, and one or both directions, and a cantilever system with a composite post to resist lateral loads.

Example 5: Other structural system, made of the composite studs as in example 1, including: composite rods or studs that are used as poles and/or posts to support electric power lines, and/or telecommunication cable lines, composite rods or studs that are used as poles and/or posts support lights along street, composite rods or studs that are used as poles and/or posts to support flags, banners, or traffic signs, composite rods or studs that are used as fence posts, and composite rods or studs that are used in space trusses, like power transmission towers, wind turbine supporting structures, construction scaffold, and stage truss segments.

Example 6: laminated composite sheathing, as shown in FIGS. 22, 23 and 24, comprising, typical structural plywood, or oriented strand board (OSB), or particle board, typical dimension 4 ft×8 ft, one or two light-gauged metal sheet of the same dimension as the plywood. In the metal sheet, there are pre-punched teeth which bite into the wooden board from one face or both faces, forming a whole piece of laminated board, or sandwich board. Optionally, there are additional pre-drilled circular holes on the metal sheet. These holes follow certain pattern to allow convenient nailing at field without additional drilling.

In summary, a composite member having a wooden core and a metal jacket with enhanced structural performance has been disclosed. The disclosure herein is intended to be illustrative, but not limiting, of the scope of the invention, which is set forth in the following claims.

What is claimed is:

1. A composite member to provide support to a structure, comprising:
a wooden core of the composite member having a perimeter and a length, the wooden core providing support to the structure; and
a metal jacket attached to the perimeter of the wooden core of the composite member and spanning the entire length, the metal jacket also providing support to the structure,
wherein additional composite mechanism is achieved through the interaction between the wooden core and the metal jacket to enhance the strength and ductility of both the wooden core and metal jacket.

2. The composite member of claim 1, wherein the wooden core is composed of at least one of: a solid nature wood, an engineered wood, or engineered plastic or foam.

3. The composite member of claim 1, wherein the metal jacket is composed of at least one of: a light-gauged cold-formed steel sheet, a stainless steel sheet, an aluminum sheet, a copper sheet, or an alloy sheet.

4. The composite member of claim 1, wherein a cross-section of the wooden core is shaped to one of: a square, a rectangle, or a circle.

5. The composite member of claim 1, wherein the metal jacket wraps entirely around the perimeter of the wooden core to form a seal.

6. The composite member of claim 1, wherein the metal jacket comprises a pattern of pre-punched teeth used to attach the metal jacket to the wooden core.

7. The composite member of claim 1, wherein the metal jacket provides lateral confinement for the wooden core to increase compressive strength and ductility of the wooden core.

8. The composite member of claim 1, wherein the wooden core provides lateral support for the metal jacket to prevent pre-mature local buckling failure of the jacket.

9. The composite member of claim 1, wherein additional composite mechanism is achieved through the interaction between the wooden core and metal jacket to enhance the overall strength and ductility of the new composite member to a level that is much higher than the sum those of wooden core and metal jacket when used alone.

10. The composite member of claim 1, wherein the metal jacket and the wooden core provide support for vertical deflection when used as a joist or beam.

11. The composite member of claim 1, wherein the metal jacket and wooden core provide support for axial displacement when used as a post or column.

12. The composite member of claim 1, wherein the composite member is part of a building lateral system, and wherein the metal jacket and the wooden core provide support for lateral force when used as a stud or post in shear walls of the building lateral system.

13. The composite member of claim 1, wherein the composite member is part of a building gravity system that comprises at least one of: a stud wall, a floor frame, a roof frame, a floor truss, and a roof truss.

14. A method for using a composite member to provide support to a structure, comprising:
providing a wooden core of the composite member having a perimeter and a length, the wooden core providing support to the structure; and
providing a metal jacket attached to the perimeter of the wooden core of the composite member and spanning the entire length, the metal jacket also providing support to the structure,
wherein additional composite mechanism is achieved through the interaction between the wooden core and the metal jacket to enhance the strength and ductility of both the wooden core and metal jacket.
